(19) United States
(12) Patent Application Publication
(10) Pub. No.: US 2010/0332613 A1
(43) Pub. Date: Dec. 30, 2010

(54) METHOD AND APPARATUS FOR PROVIDING CONTENT AND CONTEXT ANALYSIS OF REMOTE DEVICE CONTENT

(76) Inventor: Jorg Brakensiek, Mountain View, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/495,119

(22) Filed: Jun. 30, 2009

(51) Int. Cl. G06F 15/16

(52) U.S. Cl. 709/217

(57) ABSTRACT

An apparatus for providing content and context analysis of remote device content may include at least one processor and at least one memory including computer program code. The at least one memory and the computer program code may be configured, with the processor, to cause the apparatus to perform at least receiving an indication of a request to copy content to a remote device, determining a classification of the content, determining a context of the remote device, and enabling selective copying of the content to the remote device based on the classification of the content and the context. A corresponding method and computer program product are also provided.

### TECHNOLOGICAL FIELD

Embodiments of the present invention relate generally to inter-device communications technology and, more particularly, relate to an apparatus and method for providing content and context analysis of remote device content such as a remote display stream.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. In order to provide easier or faster information transfer and convenience, telecommunication industry service providers are developing improvements to existing networks. In this regard, wireless communication has become increasingly popular in recent years due, at least in part, to reductions in size and cost along with improvements in battery life and computing capacity of mobile electronic devices. As such, mobile electronic devices have become more capable, easier to use, and cheaper to obtain. Due to the now ubiquitous nature of mobile electronic devices, people of all ages and education levels are utilizing mobile terminals to communicate with other individuals or contacts, receive services and/or share information, media and other content. Moreover, for many individuals, mobile electronic devices such as portable digital assistants (PDAs), pagers, mobile televisions, mobile telephones, gaming devices, laptop computers, cameras, video recorders, audio/video players, radios, global positioning system (GPS) devices, become heavily relied upon for work, play, entertainment, socialization and other functions. Thus, many people are very connected to their respected mobile electronic devices.

Given the personal connection many people have to their mobile electronic devices, and their ability and penchant for having such devices with them, it is not uncommon for many people to prefer to use their personal mobile electronic device as a source for information and/or services, even in situations where another less flexible device is already in place to provide a particular type of information and/or service.

Accordingly, it may be desirable to provide an improved mechanism by which a mobile electronic device or mobile terminal may interface with other devices.

### BRIEF SUMMARY OF EXEMPLARY EMBODIMENTS

A method and apparatus are therefore provided that may enable the provision of content and context analysis of remote device content (e.g., a remote display stream) under certain circumstances. In this regard, for example, the mobile terminal of a user may be used to analyze content and context with respect to a content item to be served to a remote device. Accordingly, for example, a set of control functions may be conducted with respect to the service of the content item to the remote device. Thus, for example, if there are particular laws, rules or limitations on the content that is allowed or should otherwise be enabled to be served to the remote device, the mobile terminal may enable control over the presentation of the content item in accordance with the laws, rules or limitations.

In one exemplary embodiment, a method of providing content and context analysis of remote device content is provided. The method may include receiving an indication of a request to copy content to a remote device, determining a classification of the content, determining a context of the remote device, and enabling selective copying of the content to the remote device based on the classification of the content and the context.

In another exemplary embodiment, a computer program product for providing content and context analysis of remote device content is provided. The computer program product may include at least one computer-readable storage medium having computer-executable program code instructions stored therein. The computer-executable program code instructions may include program code instructions for receiving an indication of a request to copy content to a remote device, determining a classification of the content, determining a context of the remote device, and enabling selective copying of the content to the remote device based on the classification of the content and the context.

In another exemplary embodiment, an apparatus for providing content and context analysis of remote device content is provided. The apparatus may include at least one processor and at least one memory including computer program code. The at least one memory and the computer program code may be configured, with the processor, to cause the apparatus to perform at least receiving an indication of a request to copy content to a remote device, determining a classification of the content, determining a context of the remote device, and enabling selective copying of the content to the remote device based on the classification of the content and the context.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one example of a communication system according to an exemplary embodiment of the present invention;

FIG. 2 illustrates a schematic block diagram of an apparatus for providing content and context analysis of remote device content according to an exemplary embodiment of the present invention;

FIG. 3 is a block diagram of an example illustration of a system for analysis of content and context to enable control of content copying to a remote device according to an exemplary embodiment of the present invention;

FIG. 4 illustrates a flow diagram of a decision process according to an exemplary embodiment of the present invention;

FIG. 5 illustrates an exemplary vehicle context with corresponding example content being provided from a mobile terminal to a remote device according to an exemplary embodiment of the present invention; and

FIG. 6 illustrates a flowchart of a method of providing content and context analysis of remote device content in accordance with an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Some embodiments of the present invention may provide a mechanism by which improvements may be experienced in relation to providing content and context analysis of remote device content. In this regard, for example, a mobile terminal may be placed in communication with a remote device, and may enable the control the content served to the remote device. Thus, certain types of content may be edited or removed prior to rendering at the remote device based on the context and the type or classification of the content. As an example, if the mobile terminal is placed in communication with a vehicle entertainment system, the mobile terminal may be enabled to not only provide content to the vehicle entertainment system, but the mobile terminal may also be enabled to determine whether to block certain content from being sent to the vehicle entertainment system or whether some portion of the content should be blocked based on the content and the current context of the vehicle. Furthermore, in relation to providing content to the vehicle entertainment system, the mobile terminal may be a master device while the vehicle entertainment system is a slave device. This is unlike typical media players (e.g., portable music players), which are normally slave devices relative to the vehicle entertainment system acting as a master device.

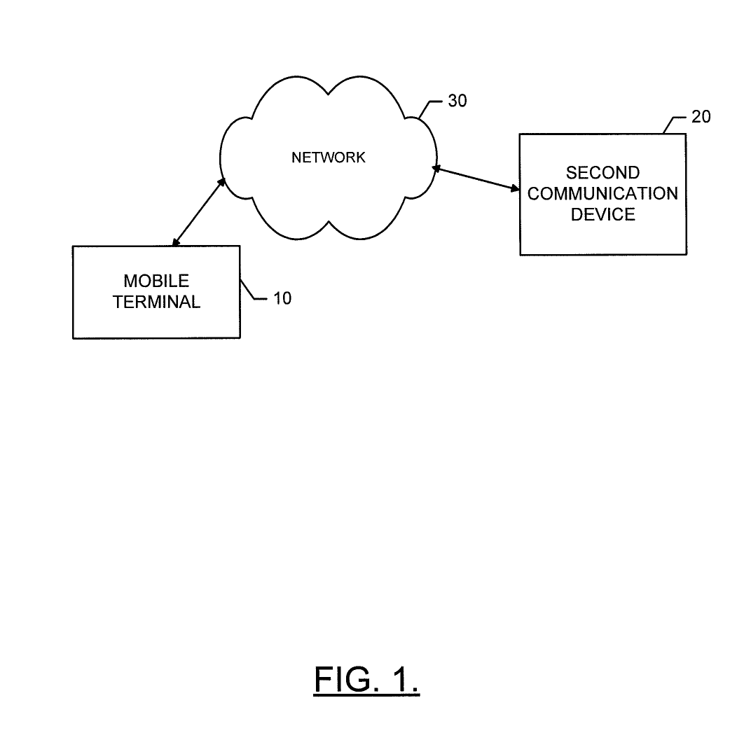

FIG. 1 illustrates a generic system diagram in which a device such as a mobile terminal 10, which may benefit from embodiments of the present invention, is shown in an exemplary communication environment. In this regard, the mobile terminal 10 may be configured to provide content and context analysis of remote device content in accordance with an exemplary embodiment. As shown in FIG. 1, an embodiment of a system in accordance with an example embodiment of the present invention may include a first communication device (e.g., mobile terminal 10) and a second communication device 20 capable of communication with each other. In an exemplary embodiment, the mobile terminal 10 and the second communication device 20 may be in communication with each other via a network 30. In some cases, embodiments of the present invention may further include one or more network devices with which the mobile terminal 10 and/or the second communication device 20 may communicate to provide, request and/or receive information.

It should be noted that although FIG. 1 shows a communication environment that may support client/server application execution, in some embodiments, the mobile terminal 10 and/or the second communication device 20 may employ embodiments of the present invention without any network communication, but instead via a direct communication link between the mobile terminal 10 and the second communication device 20. As such, for example, applications executed locally at the mobile terminal 10 and served to the second communication device 20 via a direct wired or wireless link may also benefit from embodiments of the present invention. However, it should be noted that communication techniques such as those described herein can be used not only in embedded devices, but in desktops and servers as well.

The network 30, if employed, may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. One or more communication terminals such as the mobile terminal 10 and the second communication device 20 may be in communication with each other via the network 30 or via device-to-device (D2D) communication and each may include an antenna or antennas for transmitting signals to and for receiving signals from a base site, which could be, for example a base station that is a part of one or more cellular or mobile networks or an access point that may be coupled to a data network, such as a Local Area Network (LAN), a Metropolitan Area Network (MAN), and/or a Wide Area Network (WAN), such as the Internet. In turn, other devices such as processing elements (e.g., personal computers, server computers or the like) may be coupled to the mobile terminal 10 and/or the second communication device 20 via the network 30. By directly or indirectly connecting the mobile terminal 10 and/or the second communication device 20 and other devices to the network 30 or to each other, the mobile terminal 10 and/or the second communication device 20 may be enabled to communicate with the other devices or each other, for example, according to numerous communication protocols including Hypertext Transfer Protocol (HTTP) and/or the like, to thereby carry out various communication or other functions of the mobile terminal 10 and the second communication device 20, respectively.

Furthermore, although not specifically shown in FIG. 1, the mobile terminal 10 and the second communication device 20 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, Ultra-Wide Band (UWB), Wibree techniques and/or the like. As such, the mobile terminal 10 and the second communication device 20 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In example embodiments, the first communication device (e.g., the mobile terminal 10) may be a mobile communication device such as, for example, a Personal Digital Assistant (PDA), wireless telephone, mobile computing device, camera, video recorder, audio/video player, positioning device (e.g., Global Positioning System (GPS)), game device, television device, radio device, or various other like devices or combinations thereof. The second communication device 20 may also be a mobile device such as those listed above or other mobile or embedded devices, but could also be a fixed communication device in some instances.

In an exemplary embodiment, the network 30 may provide for Virtual Network Computing (VNC) operation between the mobile terminal 10 and the second communication device 20. As such, for example, the mobile terminal 10 may serve as a VNC server configured to provide content originally executed or accessed by the mobile terminal 10 to the second communication device 20 acting as a VNC client. A VNC protocol such as RFB (remote frame buffer) or another protocol for enabling remote access to a graphical user interface may be utilized to provide communication between the mobile terminal 10 and the second communication device 20. Moreover, according to one example, the second communication device 20 may be a vehicle entertainment system (e.g., one or more speakers and one or more displays mounted in a head rest, from the ceiling, from the dashboard, or from any other portion of a vehicle such as an automobile.

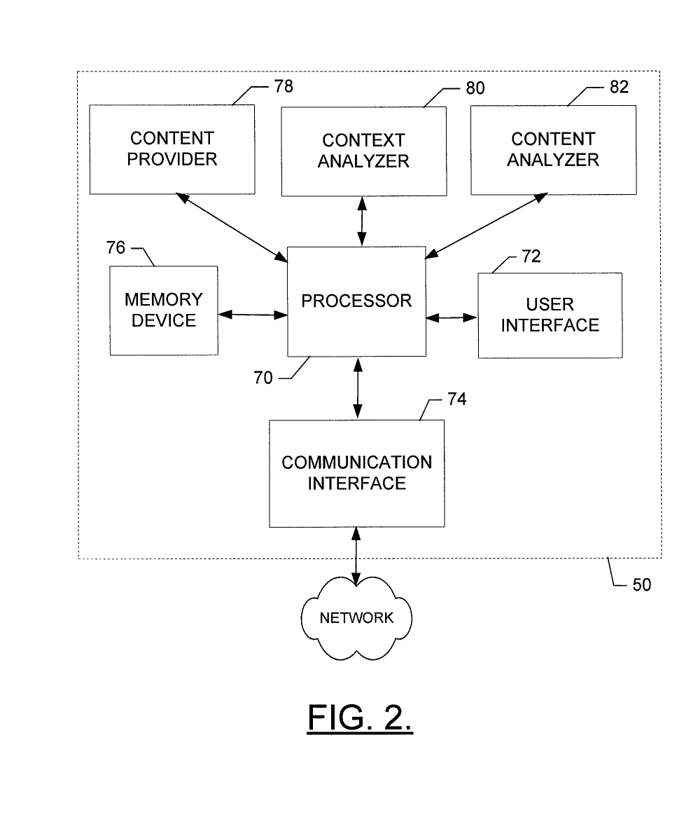

In an exemplary embodiment, the mobile terminal 10 may be configured to include or otherwise employ an apparatus according to an exemplary embodiment of the present invention. FIG. 2 illustrates a schematic block diagram of an apparatus for providing content and context analysis of remote device content according to an exemplary embodiment of the present invention. An exemplary embodiment of the invention will now be described with reference to FIG. 2, in which certain elements of an apparatus 50 for providing content and context analysis of remote device content are displayed. The apparatus 50 of FIG. 2 may be employed, for example, on a communication device (e.g., the mobile terminal 10) or a variety of other devices, such as, for example, any of the devices listed above. However, it should be noted that the components, devices or elements described below may not be mandatory and thus some may be omitted in certain embodiments. Additionally, some embodiments may include further components, devices or elements beyond those shown and described herein.

Referring now to FIG. 2, the apparatus 50 may include or otherwise be in communication with a processor 70, a user interface 72, a communication interface 74 and a memory device 76. The memory device 76 may include, for example, volatile and/or non-volatile memory. In other words, for example, the memory device 76 may be an electronic storage device comprising gates configured to store data (e.g., bits) that may be retrievable by a machine (e.g., a computing device). The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal) adapted for employing embodiments of the present invention by further configuration of the processor 70 by instructions for performing the algorithms and/or operations described herein. The processor 70 may include, among other things, a clock and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like.

In an exemplary embodiment, the processor 70 may be embodied as, include or otherwise control a content provider 78, context analyzer 80 and a content analyzer 82. The content provider 78, the context analyzer 80 and the content analyzer 82 may each be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the content provider 78, the context analyzer 80 and the content analyzer 82 as described herein. Thus, in examples in which software is employed, a device or circuitry (e.g., the processor 70 in one example) executing the software forms the structure associated with such means.

The content provider 78 may be configured to provide selected content to a remote device (e.g., the second communication device) based on the content and the context of the apparatus 50. In this regard, the content provider 78 may receive content from an application or service being executed by or otherwise providing content to the apparatus 50 and communicate selected portions of the content to the remote device based on the content and the context of the apparatus 50. In an exemplary embodiment, the content provider 78 may receive input from the context analyzer 80 as to the context of the apparatus 50 and receive input from the content analyzer 82 as to the content to be provided. Based on the context, the content and a predetermined rule set or enforcement paradigm, the content provider 78 may select either all, a portion or none of the content to be communicated to the remove device. In an exemplary embodiment, as indicated above, a remote frame buffer copying process may be employed to copy frames from the content at the mobile terminal 10 in a first frame buffer over to a second frame buffer at the second communication device 20 for rendering thereat.

The context analyzer 80 may be configured to determine the context environment of a device such as the mobile terminal 10 (or the second communication device 20). In some embodiments, the context determination may be generic (e.g., moving or stationary). However, in other embodiments, the context determination may be more specific (e.g., the device being in an automotive context, movement of the device above or below a predetermined speed, the device being in a particular location, etc.). The context analyzer 80 may also be in communication with a movement or other environmental sensor of either the mobile terminal 10 or the second communication device 20 (e.g., a GPS device, cell-tower tracking sensor, or other positioning sensor) in order to receive context information related to location and/or motion (including speed in some cases).

Context information determined by the context analyzer 80 may be determined based on analysis accomplished on the basis of either static or dynamic settings. In this regard, for example, static user settings input by the user may be utilized to determined context information. For example, if the user starts a copying process with regard to frame buffer data, a static user setting may determine by default that the initiation of the copying process confirms an automotive context for the apparatus 50. Dynamic user settings may also be used whereby the user sets a configuration indicating that the user is in a particular context (e.g., via selection from a list of potential contexts or selection of one particular context (e.g., a vehicle context) with which an embodiment is configured to operate). In an exemplary embodiment configured to operate in a vehicle context, if the apparatus 50 is determined to be in the vehicle context, embodiments of the present invention may select content for copying to the remote device based on the type of content and based on the rule set governing presentation of content via a vehicle entertainment system. For example, if local rules or regulations provide that the console display of an automobile not be enabled to provide video or other distracting content to the user above a particular speed, the context information may be indicative of whether the apparatus 50 is in a vehicle context and, in this example, whether the speed is above or below the particular speed. The context information may then be provided to the content provider 78 in order for the content provider 78 to determined whether some portion (or all) of the content should be blocked from provision to the second communication device 20.

The content analyzer 82 may be configured to analyze content originating or accessed at the mobile terminal 10 that is possible for copying to the remote device (e.g., the second communication device 20) to determine a classification or type of the content. In this regard, for example, the content analyzer 82 of one example embodiment is configured to investigate the content of a frame buffer, which may include content to be copied to a remote display, to analyze aspects or characteristics of the frame buffer content. As an example, the content analyzer 82 may be configured to analyze timing aspects of frame buffer changes to determine a classification of the content. In some cases, timing aspects such as update rate may be indicative of content classification. For example, video data is typically updated at a given frame rate (e.g., 30 frames per second). Meanwhile, changes to map data such as zooming, rotation or shift, and other changes may be clearly identified using correlation analysis. Focus change, exposure events, or events such as the windowing system placing another window over a prior window, may also be taken into account by the content analyzer 82 as being indicative of content classification in some cases.

Accordingly, the content analyzer 82 may be configured to analyze frame buffer contents to decide whether data in a frame buffer is allowed to be shown on the remote display without distracting the driver based on the content classification. For example, by monitoring and tracking frame buffer update and/or refresh rates with respect to certain thresholds, the content analyzer 82 may be enabled to determine a content classification of the content corresponding to the frame buffer. In some examples, dynamic content may be exchanged with “old” content, which may automatically lead to an update rate of or near the threshold. In some cases, changes in window focus (e.g., another window being put on top of a window stack) may not be taken into account.

In an exemplary embodiment, the content analyzer 82 may be enabled to perform content analysis of portions of frames as well. Thus, for example, if a portion of content is video, while other portions are text or map data, the content analyzer 82 may be configured to identify portions for which presentation limitations may apply at the remote device (e.g., video portions) and portions for which presentation limits are different or do not apply at all (e.g., map data, audio data, text data, etc.). In some cases, the content analyzer 82 may analyze information about concurrently running processes or other currently used parts of the processor (e.g., a decoder, a video decoding hardware accelerator or other processes) that may provide an indication of the classification of content in the frame buffer as well.

In some embodiments, the content provider 78, the context analyzer 80 and the content analyzer 82 may all be embodied at the mobile terminal 10 so that the mobile terminal 10 actually filters out or otherwise selects content to be provided to the second communication device 20. However, while in some cases, the content provider 78 may provide the selected portions of the content to the second communication device 20 as described above, in other cases the content provider 78 may provide the content and the context and content information to the second communication device 20 and the second communication device may utilize the context and content information to determine which portions, if any, of the content are to be displayed. Thus, in an exemplary embodiment, the content provider 78 provides enablement for the control of content to be displayed at a remote device, but does not necessarily itself provide the content to be displayed. Instead, in at least one embodiment, the content provider 78 provides the content (e.g., unaltered) and data or instructions indicative of which portions are displayable at the second communication device 20. The second communication device 20 then receives the unaltered content and the instructions and displays the displayable portions of the content based on the instructions.

In an exemplary embodiment, the content provider 78 may provide for buffering or storage of content that is not selected for provision to the second communication device 20 based on context and content classification. Accordingly, if the content is blocked from being copied to the second communication device 20 for context reasons that clear at some future time, and the content is not time sensitive, the content may be provided to the second communication device 20 after the context reasons have cleared. Thus, for example, if the content provider 78 provides map data regarding navigating to a particular destination and also provides supplemental information such as video or lengthy text information that is not to be displayed while the user is driving a vehicle associated with the second communication device, the map data may be copied to the second communication device but the supplemental information may be blocked while the user is driving. The supplemental information may, however, be buffered and presented to the user when the user parks the vehicle or reduces speed below a threshold. Alternatively or additionally, the non-visual portions of content may be presented to the user (e.g., an audio stream) such that video or other visual portions of the content are suppressed under appropriate circumstances.

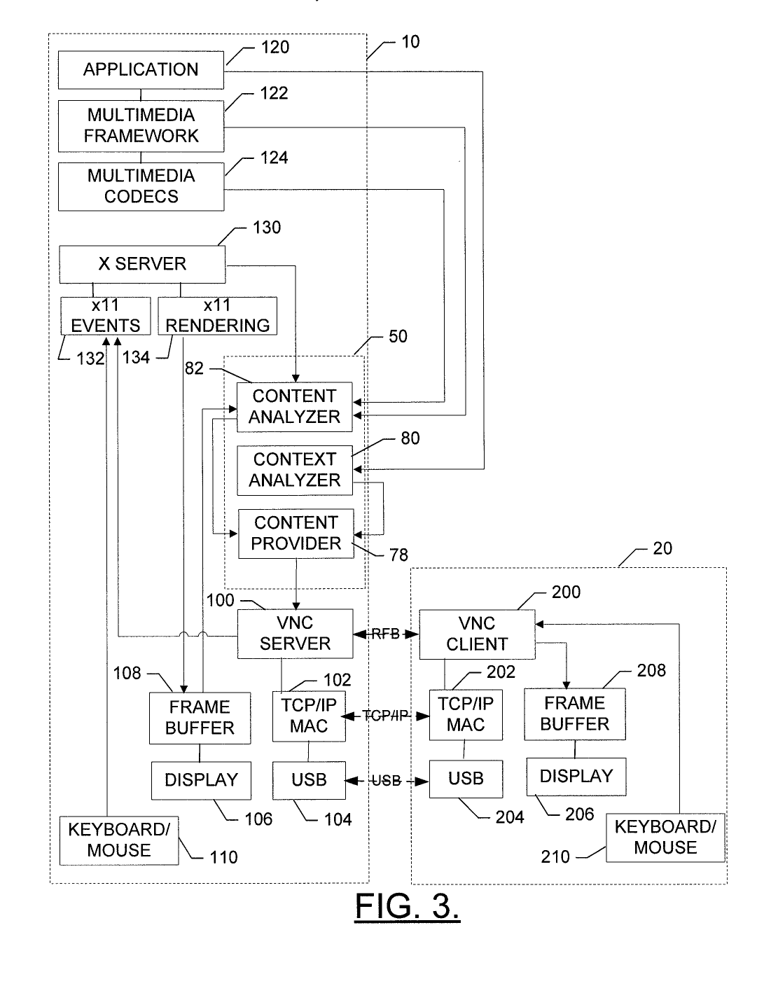

An exemplary embodiment of the present invention will now be described in reference to FIG. 3, which illustrates a block diagram of a system according to an example embodiment. Notably, the lines connecting certain elements of FIG. 3 are not illustrative of the only connections between components of the device illustrated. Instead, the lines connecting certain elements of FIG. 3 are only used to exemplify specific connections of interest in relation to carrying out one example embodiment of the present invention.

As shown in FIG. 3, an embodiment of the present invention may include a first device (e.g., the mobile terminal 10) including the apparatus 50 and a second device (e.g., the second communication device 20) capable of communication with each other. As shown in FIG. 3, the mobile terminal 10 may act as or otherwise include a VNC server 100 while the second communication device 20 acts as or otherwise includes a VNC client 200. The VNC server 100 and the VNC client 200 may communicate with each other via a protocol such as RFB. Other communication may be provided via TCP/IP (Transport Control Protocol/Internet Protocol or USB using TCP/IP Media Access Control (MAC) modules (e.g., TCP/IP MAC module 102 and TCP/IP MAC module 202), TCP/IP connection over USB or USB modules (e.g., USB module 104 and USB module 204) at each device, respectively. In an exemplary embodiment, each of the first device and the second device may have a display (e.g., display 106 and display 206) that may display content in a corresponding frame buffer (e.g., frame buffer 108 and frame buffer 208). The first and second devices may also each have their own respective user interfaces (e.g., keyboard/mouse 110 and keyboard/mouse 210) to facilitate the receipt of user instructions.

As described above, the frame buffer 108 of the first device may have content to be copied to the frame buffer 208 of the second device in accordance with an exemplary embodiment. The content may be produced by or in association with a particular application (e.g., application 120) that may run on a multimedia framework 122 of the first device. The multimedia framework 122 may, for example, be a media player including or controlled by the processor 70 and may further include multimedia codecs 124 used to encode and/or decode multimedia content using any suitable encoding/decoding techniques. In an exemplary embodiment, the content provider 78 may include or otherwise be in communication with an X server 130. The X server 130 may be a computer, portion of a computer or software program run on a computer configured to provide protocol support and processing for VNC network operation. As such, the X server 130 may be configured to enable the provision of content to the apparatus 50 so that the content can be analyzed (e.g., by the content analyzer 82) in accordance with an exemplary embodiment. In some embodiments, the X server may control or include an x11 event module 132 and an x11 rendering module 134.

The x11 event module 132 and the x11 rendering module 134 may each be any means such as a device or circuitry operating in accordance with software or otherwise embodied in hardware or a combination of hardware and software thereby configuring the device or circuitry to perform the corresponding functions of the x11 event module 132 and the x11 rendering module 134, respectively, as described herein. The x11 event module 132 may be configured to receive user interface events (e.g., from the keyboard/mouse 110) and input from the VNC server 100. Meanwhile, the x11 rendering module 134 may be configured to provide content received from the X server 130 to the frame buffer 108 for potential copying to the frame buffer 208 via VNC. In this regard, for example, after receiving content from the x11 rendering module 134, the content may be provided to the VNC server 100, which may provide selected portions of the content (e.g., based on control provided by the content provider 78) to the VNC client 200. Alternatively, as indicated above, the VNC server 100 may provide (e.g., under the control of the content provider 78) the content along with indications regarding which selected portions are to be displayed at the second device. Notably, the frame buffer 108 (or frame buffer 208) may be embodied as a physical frame buffer or a virtual frame buffer.

Accordingly, an exemplary embodiment of the present invention provides for local enforcement or remote enforcement of rules, applicable laws or guidelines impacting the display of certain types or classes of content on a particular remote device (e.g., speed dependent presentation of video content on the head unit or dashboard mounted vehicle entertainment system of a vehicle) based on the content and the context associated with presentation of the content. The remote enforcement embodiment of one example utilizes a mobile device to provide content and context analysis regarding content to be shared with a remote device. Information associated with the analysis is then provided (e.g., as meta information) along with the content as frame buffer data sent to a remote display. The remote device then shows selected portions of the content based on the meta information. The local enforcement embodiment of one example utilizes a mobile device to provide selected content to the frame buffer of a remote device. The selected content is chosen by the mobile device based on content and context analysis regarding content to be shared with the remote device. In some cases, the local enforcement embodiment may provide for sharing content with the remote device via a reduced bandwidth link due to the fact that less content may be shared and no meta information is necessarily shared. Instead, for example, only the frame data (and in some cases a reduced amount of frame data) may be copied to the remote frame buffer. In either case, content may be fully or partially removed in instances where dynamic parts of stream content are to be removed based on the context and class of the content.

For example, if map data is being displayed and a video stream is to be overlaid on the map data, the video stream may be overlaid on the map data and displayed at the remote device if the vehicle in which the remote device is located is not moving. However, if the vehicle in which the remote device is located is moving above a threshold speed, the video stream portion may be removed and only the map data may be provided to and/or displayed at the remote device. In situations where speed decreases to below a threshold at which display of video streams is allowable, the decrease in speed to below the threshold may be detected as an exposure event and the presentation of video may be enabled by the apparatus 50. Thereafter, for the time period during which the speed is below the threshold, the video stream may be overlaid over the map data.

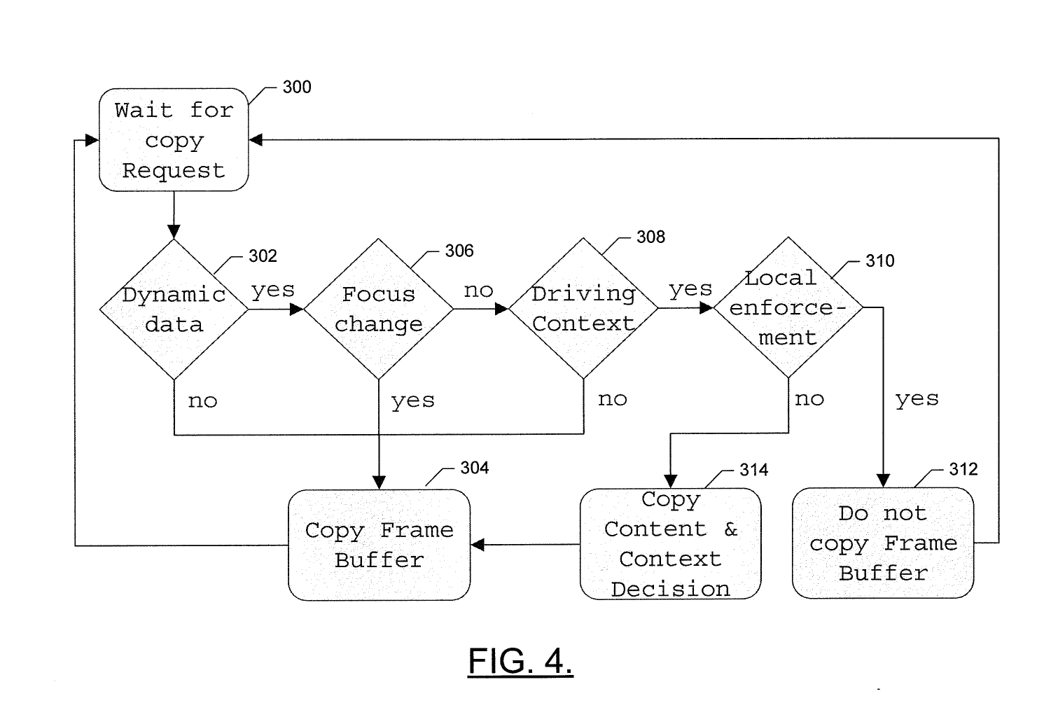

Thus, according to an exemplary embodiment, the apparatus 50 is configured to provide analysis of content to be provided to a remote device in relation to the class of the content and the context of the remote device. Based on the class of the content and the context of the remote device, the apparatus 50 makes a determination as to whether to provide the content to the remote device. A block diagram of the decision process associated with one exemplary embodiment of the present invention is provided in connection with FIG. 4. In reference to FIG. 4, the apparatus 50 may initially await a copy request regarding data requested to be copied to a remote device at operation 300. The apparatus 50 may then determined whether the data is dynamic data at operation 302. If the data is not dynamic data, then the data may be copied to the frame buffer of the remote device at operation 304. However, if the data is dynamic data (e.g., if the data is indicative of frames changing at a relatively rapid rate that may be indicative of video content) and a focus change is detected at operation 306, then it may be determined that the content is likely not video or otherwise potentially prohibited content and the data may be copied to the frame buffer of the remote device at operation 304. If the data is dynamic data and there is no focus change, a determination may be made at operation 308 as to whether the remote device is in a driving context. If the remote device is not in a driving context, the data may be copied to the frame buffer of the remote device at operation 304. However, if the remote device is in the driving context, then a determination may be made as to whether local or remote enforcement is in place at operation 310. If local enforcement is in place, the dynamic data may not be copied to the frame buffer of the remote device as indicated at operation 312 and the apparatus 50 may again await a copy request. However, if local enforcement is not in place (e.g., if remote enforcement is in effect), then the content may be copied to the frame buffer of the remote device at operation 304, but information about the content and context may also be provided to the remote device at operation 314.

Thus, some embodiments of the present invention describe mechanisms by which local or remote enforcement of rules or guidelines describing the desirability (or permissibility) of displaying certain content at a remote device under certain conditions (e.g., contexts) is provided. Accordingly, some embodiments of the present invention enable content and context analysis of content that is to be provided to a remote device and utilize the content and context analysis to provide an ability to control the presentation or copying of the content to the remote device based on the content and context analysis.

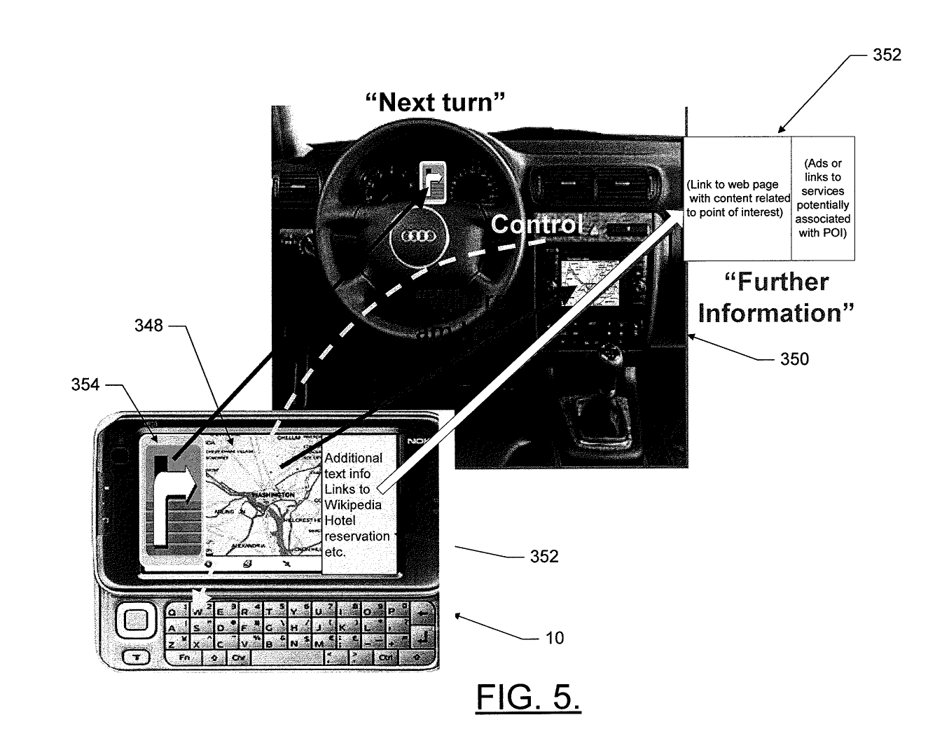

An example use case is shown in FIG. 5, which illustrates an exemplary vehicle context with corresponding example content. In this regard, for example, a driver may be operating his or her vehicle with a map application running via the mobile terminal 10 of the driver. The map application may provide map data 348 to the display of a vehicle in-dash console 350 by copying frames from a frame buffer of the mobile terminal 10 to a frame buffer of the vehicle in-dash console 350. Further information 352 such as text information about one or more objects on the map or about products, services or businesses of interest may also be provided on the display of the mobile terminal 10. The further information could be video information or other dynamic content in some other cases. In some cases, audible driving instructions may also be provided as indicated by object 354. Based on the vehicle being above a particular speed, embodiments of the present invention may provide for removal of the further information 352 from the display of the vehicle in-dash console 350 to prevent distraction of the driver. However, the map data 348 and the audible driving instructions may still be presented at the display of the vehicle in-dash console 350.

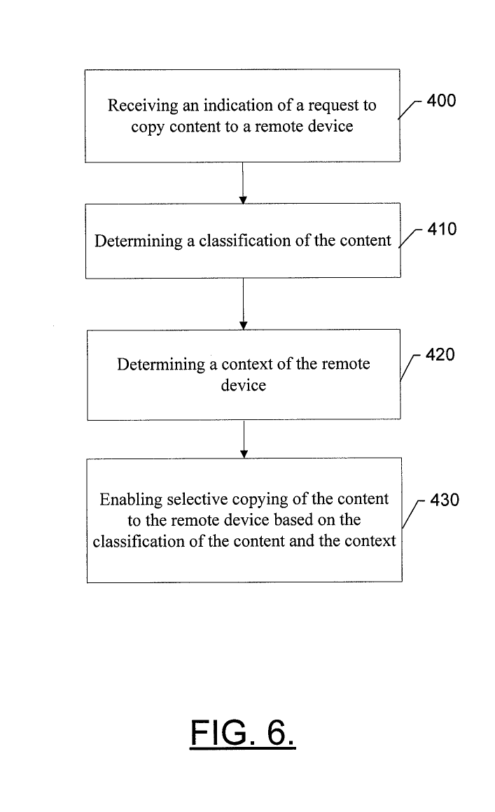

FIG. 6 is a flowchart of a system, method and program product according to exemplary embodiments of the invention. It will be understood that each block or step of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of the mobile terminal or network device and executed by a processor in the mobile terminal or network device. As will be appreciated, any such computer program instructions may be loaded onto a computer or other programmable apparatus (e.g., hardware) to produce a machine, such that the resulting computer or other programmable apparatus embody means for implementing the functions specified in the flowchart block(s) or step(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing content and context analysis of remote device content, as shown in FIG. 6, includes receiving an indication of a request to copy content to a remote device at operation 400 and determining a classification of the content at operation 410. The method may further include determining a context of the remote device at operation 420 and enabling selective copying of the content to the remote device based on the classification of the content and the context at operation 430. Notably, the ordering of operations 410 and 420 is not important.

In some embodiments, certain ones of the operations above may be modified or further amplified as described below. In this regard, for example, determining the classification of the content may include determining whether the content includes dynamic data and/or determining whether the content includes dynamic data that corresponds to a focus change. In some cases, determining the context includes determining whether the remote device is in a vehicle context (e.g., whether the remote device is a vehicle entertainment system) or determining movement of the remote device relative to a threshold. The movement of the remote device may be indicative of the remote device being in a driving context (e.g., in a vehicle moving at greater than a predefined speed). In some cases, the determination of vehicle context may be made by a sensor or by static or dynamic user settings. Meta information of various types may also be used to determine vehicle context. In an exemplary embodiment, enabling selective copying may include removing at least a portion of the content prior to copying the content to the remote device (e.g., local enforcement) or providing the content to the remote device and providing indications regarding portions of the content that are to be removed (e.g., remote enforcement). With respect to local enforcement, enabling selective copying may include removing at least a portion of the content that corresponds to dynamic data in response to the context of the remote device indicating a driving context. With respect to remote enforcement, enabling selective copying may include providing the content to the remote device and providing indications regarding portions of the content that correspond to dynamic data to be removed in response to the context of the remote device indicating a driving context. The content may be provided in individual streams of static and dynamic content. As such, in remote enforcement, the remote device may receive both the static and dynamic content and provide enforcement with respect to the dynamic content when indications regarding context indicate conditions under which the dynamic content is to be withheld from presentation to the user.

In an exemplary embodiment, an apparatus for performing the method of FIG. 6 above may comprise a processor (e.g., the processor 70) configured to perform some or each of the operations (400-430) described above. The processor may, for example, be configured to perform the operations (400-430) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 400-430 may comprise, for example, the processor 70, respective ones of the content provider 78, the context analyzer 80 and the content analyzer 82, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the processor, cause the apparatus to at least perform:
receive an indication of a request to copy content to a remote device;
determine a classification of the content;
determine a context of the remote device; and
enable selective copying of the content to the remote device based on the classification of the content and the context.

2. The apparatus of claim 1, wherein the program code causes the apparatus to determine the classification of the content by determining whether the content includes dynamic data.

3. The apparatus of claim 1, wherein the program code causes the apparatus to determine the classification of the content by determining whether the content includes dynamic data that corresponds to a focus change.

4. The apparatus of claim 1, wherein the program code causes the apparatus to determine the context by determining whether the remote device is in a vehicle context.

5. The apparatus of claim 1, wherein the program code causes the apparatus to apparatus to determine the context by determining movement of the remote device relative to a threshold.

6. The apparatus of claim 1, wherein the program code causes the apparatus to enable selective copying by removing at least a portion of the content prior to copying the content to the remote device.

7. The apparatus of claim 1, wherein the program code causes the apparatus to enable selective copying by removing at least a portion of the content that corresponds to dynamic data in response to the context of the remote device indicating a driving context.

8. The apparatus of claim 1, wherein the program code causes the apparatus to enable selective copying by providing the content to the remote device and providing indications regarding portions of the content that are to be removed.

9. The apparatus of claim 1, wherein the program code causes the apparatus to enable selective copying by providing the content to the remote device and providing indications regarding portions of the content that correspond to dynamic data to be removed in response to the context of the remote device indicating a driving context.

10. A method comprising:
receiving an indication of a request to copy content to a remote device;
determining a classification of the content;
determining a context of the remote device; and
enabling selective copying of the content to the remote device based on the classification of the content and the context.

11. The method of claim 10, wherein determining the classification of the content comprises determining whether the content includes dynamic data.

12. The method of claim 10, wherein determining the classification of the content comprises determining whether the content includes dynamic data that corresponds to a focus change.

13. The method of claim 10, wherein determining the context comprises determining whether the remote device is in a vehicle context.

14. The method of claim 10, wherein determining the context comprises determining movement of the remote device relative to a threshold.

15. The method of claim 10, wherein enabling selective copying comprises removing at least a portion of the content prior to copying the content to the remote device.

16. The method of claim 10, wherein enabling selective copying comprises removing at least a portion of the content that corresponds to dynamic data in response to the context of the remote device indicating a driving context.

17. The method of claim 10, wherein enabling selective copying comprises providing the content to the remote device and providing indications regarding portions of the content that are to be removed.

18. The method of claim 10, wherein enabling selective copying comprises providing the content to the remote device and providing indications regarding portions of the content that correspond to dynamic data to be removed in response to the context of the remote device indicating a driving context.

19. A computer program product comprising at least one computer-readable storage medium having computer-executable program code portions stored therein, the computer-executable program code portions comprising:
program code instructions for receiving an indication of a request to copy content to a remote device;
program code instructions for determining a classification of the content;
program code instructions for determining a context of the remote device; and
program code instructions for enabling selective copying of the content to the remote device based on the classification of the content and the context.

20. The computer program product of claim 19, wherein program code instructions for enabling selective copying include instructions for removing at least a portion of the content prior to copying the content to the remote device.
